(19) United States
(12) Patent Application Publication
(10) Pub. No.: US 2025/0265484 A1
(43) Pub. Date: Aug. 21, 2025

(54) LEARNING-BASED QUANTUM EXPERIMENTAL SETUP SELECTION

(71) Applicant: International Business Machines Corporation, Armonk, NY (US)

(72) Inventors: Ritajit Majumdar, Kolkata (IN); Anupama Ray, Bangalore (IN); Iskandar Sitdikov, New York, NY (US); Caleb Johnson, Austin, TX (US)

(21) Appl. No.: 18/443,568

(22) Filed: Feb. 16, 2024

(51) Int. Cl. G06N 10/20

(52) U.S. Cl. CPC G06N 10/20

(57) ABSTRACT

According to one embodiment, a method, computer system, and computer program product for quantum setup selection is provided. The embodiment may include receiving a quantum circuit and one or more user credentials. The embodiment may further include identifying one or more quantum hardware units available to a user based on the user credentials and the quantum circuit. The embodiment may also include generating a score for an orientation of the one or more quantum hardware units and the quantum circuit using noise information and a queuing delay for the one or more quantum hardware units and a pretrained machine learning model. The embodiment may further include generating outputs for the orientation based on the generated scores.

### BACKGROUND

The present invention relates generally to the field of quantum computing, and more particularly to recommending a best fit, available hardware device for a user-provided circuit.

Quantum computing relates to a field computing that leverages the principles of quantum mechanics to process information at exponentially increasing rates based on the number of quantum bits, or qubits, available. Quantum computers have the capability to process vast amounts of computational processes simultaneously, which may allow for the solving of complex problems that are currently unavailable or infeasible using classical computers.

### SUMMARY

According to one embodiment, a method, computer system, and computer program product for quantum setup selection is provided. The embodiment may include receiving a quantum circuit and one or more user credentials. The embodiment may further include identifying one or more quantum hardware units available to a user based on the user credentials and the quantum circuit. The embodiment may also include generating a score for an orientation of the one or more quantum hardware units and the quantum circuit using noise information and a queuing delay for the one or more quantum hardware units and a pretrained machine learning model. The embodiment may further include generating outputs for the orientation based on the generated scores.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2A illustrates components of a hybrid quantum-classical computing system according to at least one embodiment.

FIG. 2B illustrates an example workflow in the hybrid quantum-classical computing system according to at least one embodiment.

FIG. 3 illustrates modules of a quantum setup selection program according to at least one embodiment.

FIG. 4 illustrates an operational flowchart for a quantum setup selection process according to at least one embodiment.

FIG. 5 illustrates an operational flowchart for a selection module process according to at least one embodiment.

FIG. 6 illustrates a functional block diagram of a quantum circuit executed without parallelization according to at least one embodiment.

FIG. 7 illustrates a functional block diagram of a quantum circuit executed with intra-device parallelization according to at least one embodiment.

FIG. 8 illustrates a function block diagram of a quantum circuit executed with inter-device parallelization according to at least one embodiment.

FIG. 9 illustrates an operational flowchart of a learner module pretraining a machine learning model on multiple families of circuits according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of quantum computing. The following described exemplary embodiments provide a system, method, and program product to, among other things, recommend a best fit, available hardware device for a user-provided circuit. Therefore, the present embodiment has the capacity to improve the technical field of quantum computing by optimizing experimental orientations for problem execution based on available hardware, mitigation needs, available algorithms, and circuits. Furthermore, the present embodiment may improve resource conversation due to an identification of computing devices, including quantum computing devices, that can most efficiently execute the user jobs. The optimizations may also result in insights as to how and why certain devices receive greater utilization for particular types of problems.

As previously described, quantum computing relates to a field computing that leverages the principles of quantum mechanics to process information at exponentially increasing rates based on the number of quantum bits, or qubits, available. Quantum computers have the capability to process vast amounts of computational processes simultaneously, which may allow for the solving of complex problems that are currently unavailable or infeasible using classical computers.

Typically, when a user wishes to utilize a quantum computer, the user must first generate a job (e.g., a circuit) to be transpiled or performed on the hardware (e.g., quantum systems) accessible to the user. However, different users may have access to different hardware devices on which to execute the desired job. Execution of the job on a single hardware device currently available for processing may be less efficient than another type of execution orientation. As such, it may be advantageous to, among other things, analyze the user input job and the available hardware devices to devise an optimal orientation of computing resources to execute the job.

According to at least one embodiment, a quantum setup selection program may receive a user input, such as a job the user wishes to execute on a hardware device. The quantum setup selection program may analyze the available hardware device (e.g., classical and quantum hardware devices) to determine which are large enough to accommodate the user input. In one or more embodiments, the quantum setup selection program may use circuit-knitting to create subcircuits that are capable of execution on the available hardware devices. If multiple user input jobs exist, the quantum setup selection program may generate one or more suggestions of possible combinations of hardware devices on which to execute the circuits or subcircuits. Using a recommender engine, the quantum setup selection program may suggest a hardware device or a set of hardware devices on which to execute the job, circuit, or subcircuit based on a machine learning model trained on a previous job execution history. The quantum setup selection program may utilize the output from the executed job on the hardware device or the set of hardware devices, such as quality degradation, queuing delay, running time, and classical overhead for circuit-knitting, to further train the machine learning model.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

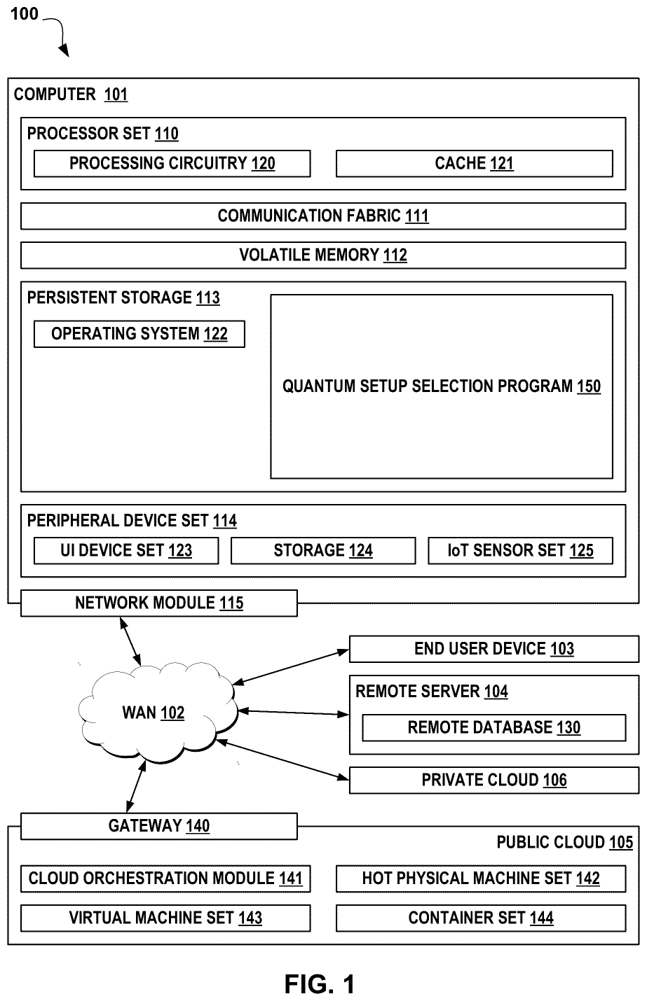

Referring now to FIG. 1, computing environment 100 contains an example of an environment for the execution of at least some of the computer code involved in performing the inventive methods, such as quantum setup selection program 150. In addition to quantum setup selection program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and quantum setup selection program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in quantum setup selection program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in quantum setup selection program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to at least one embodiment, the quantum setup selection program 150 may receive a user input intended for execution, in whole or in part, on a quantum computer. The user input may include algorithms, circuits, hardware device access, selection of analysis using parallelization, and, if parallelization is selected, the parallelization type (e.g., intra-device parallelization or inter-device parallelization). The quantum setup selection program 150 may then score each available hardware to make use of calibration data for each hardware device and identify the noise in the device. Based on the calculated score for each hardware device and past execution history for similar user inputs, the quantum setup selection program 150, using a recommender engine, may identify a preconfigured number of hardware setups. The quantum setup selection program 150 may further utilize a learner module to train a machine learning model to assist in identifying appropriate and/or efficient hardware setup for future user inputs. The quantum setup selection program 150 may then output data that predicts the setups expected to provide the best outcomes in terms of performance, queuing delay, or any other configurable metric.

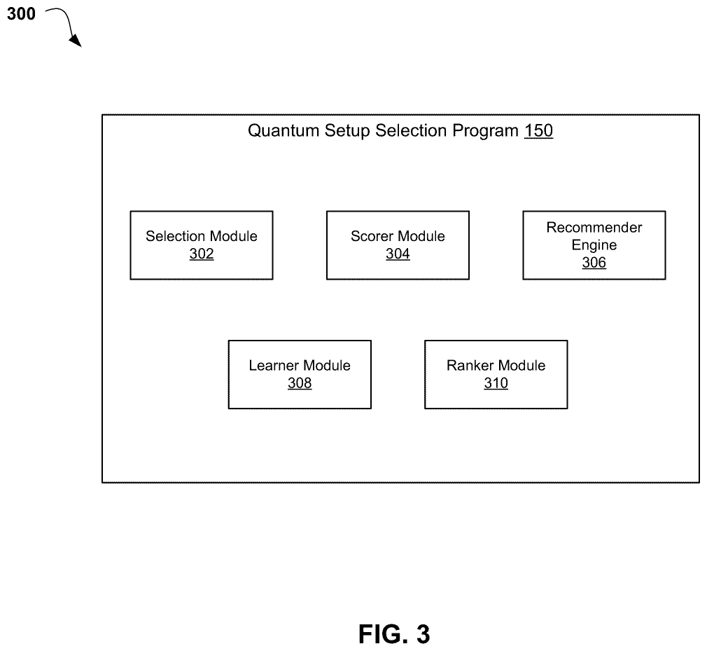

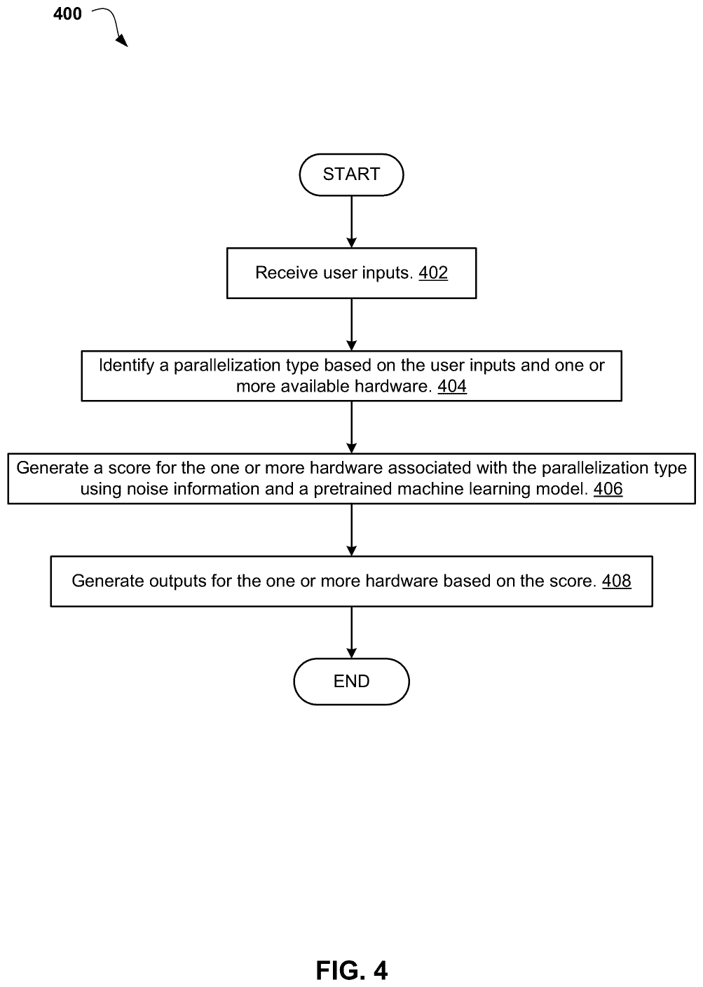

Additionally, prior to initially performing any actions, the quantum setup selection program 150 may perform an opt-in procedure. The opt-in procedure may include a notification of the data the quantum setup selection program 150 may capture and the purpose for which that data may be utilized by the quantum setup selection program 150 during data gathering and operation. Furthermore, notwithstanding depiction in computer 101 in FIG. 1, the quantum setup selection program 150, as part of classical backend 220, may be stored in and/or executed by, individually or in any combination, end user device 103, remote server 104, public cloud 105, and private cloud 106. The quantum setup selection method is explained in more detail below with respect to FIGS. 3 and 4.

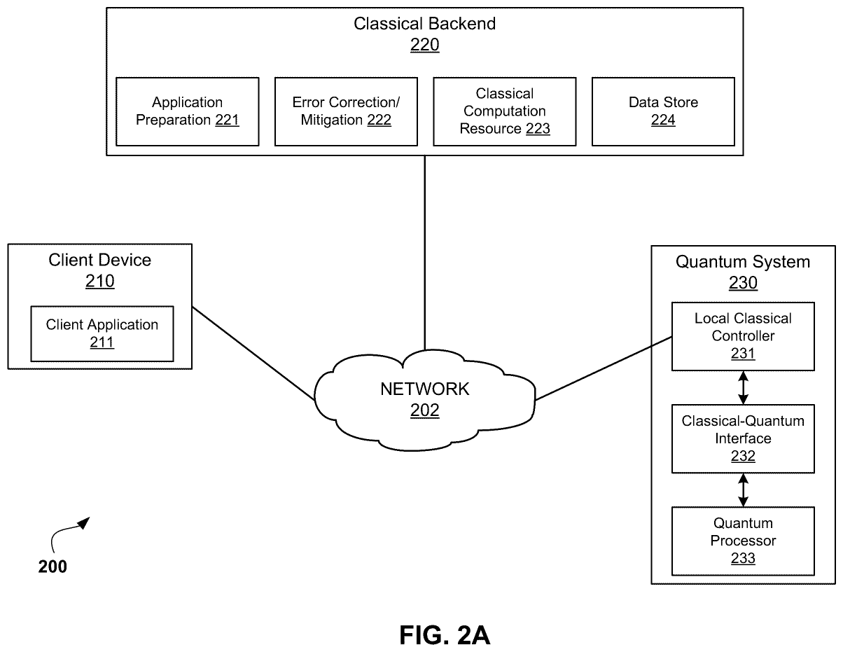

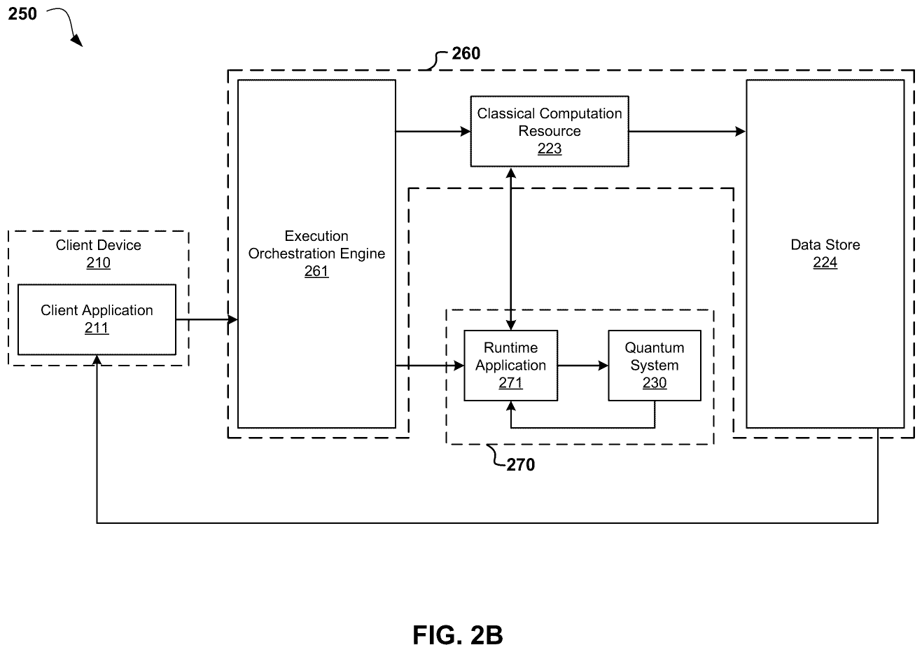

Referring now to FIG. 2A, components of a hybrid quantum-classical computing system are depicted, according to at least one embodiment. As shown, a client device 210 may interface with a classical backend 220 to enable computations with the aid of a quantum system 230.

Network 202 may be any combination of connections and protocols that will support communications between the client device 210, the classical backend 220, and the quantum system 230. In an example embodiment, network 202 may WAN 102.

Client device 210 may be an implementation of computer 101 or EUD 103, described in more detail with reference to FIG. 1, configured to operate in a hybrid computing system 200.

Client application 211 may include an application or program code that includes computations requiring a quantum algorithm or quantum operation. In an embodiment, client application 211 may include an object-oriented programming language, such as Python® (“Python” is a registered trademark of the Python Software Foundation), capable of using programming libraries or modules containing quantum computing commands or algorithms, such as QISKIT (“QISKIT” is a registered trademark of the International Business Machines Corporation). In another embodiment, client application 211 may include machine level instructions for performing a quantum circuit, such as OpenQASM. Additionally, user application may be any other high-level interface, such as a graphical user interface, having the underlying object oriented and/or machine level code as described above.

The classical backend 220 may be an implementation of computer 101, described in more detail with reference to FIG. 1, having program modules configured to operate in a hybrid computing system 200. Such program modules for classical backend 220 may include algorithm preparation 221, error correction/mitigation 222, classical computing resource 223, and data store 224.

Algorithm preparation 221 may be a program or module capable of preparing algorithms contained in client application 211 for operation on quantum system 230. Algorithm preparation 221 may be instantiated as part of a larger algorithm, such as a function call of an API, or by parsing a hybrid classical-quantum computation into aspects for quantum and classical calculation. Algorithm preparation 221 may additionally compile or transpile quantum circuits that were contained in client application 211 into an assembly language code for use by the local classical controller 231 to enable the quantum processor 233 to perform the logical operations of the circuit on physical structures. During transpilation/compilation an executable quantum circuit in the quantum assembly language may be created based on the calculations to be performed, the data to be analyzed, and the available quantum hardware. In one example embodiment, algorithm preparation 221 may select a quantum circuit from a library of circuits that have been designed for use in a particular problem. In another example embodiment, algorithm preparation 221 may receive a quantum circuit from the client application 211 and may perform transformations on the quantum circuit to make the circuit more efficient, or to fit the quantum circuit to available architecture of the quantum processor 233. Additionally, algorithm preparation 221 may prepare classical data from data store 224, or client application 211, as part of the assembly language code for implementing the quantum circuit by the local classical controller 231. Algorithm preparation 221 may additionally set the number of shots (i.e., one complete execution of a quantum circuit) for each circuit to achieve a robust result of the operation of the algorithm. Further, algorithm preparation 221 may update, or re-compile/re-transpile, the assembly language code based on parallel operations occurring in classical computing resource 223 or results received during execution of the quantum calculation on quantum system 230. Additionally, algorithm preparation 221 may determine the criterion for convergence of the quantum algorithm or hybrid algorithm.

Error Suppression/Mitigation 222 may be a program or module capable of performing error suppression or mitigation techniques for improving the reliability of results of quantum computations. Error suppression is the most basic level of error handling. Error suppression refers to techniques where knowledge about the undesirable effects of quantum hardware is used to introduce customization that can anticipate and avoid the potential impacts of those effects, such as modifying signals from Classical-quantum interface 232 based on the undesirable effects. Error mitigation uses the outputs of ensembles of circuits to reduce or eliminate the effect of noise in estimating expectation values. Error mitigation may include techniques such as Zero Noise Extrapolation (ZNE) and Probabilistic Error Correction (PEC).

Classical computing resource 223 may be a program or module capable of performing classical (e.g., binary, digital) calculations contained in client application 211. Classical calculations may include AI/ML algorithms, floating point operations, and/or simulation of Quantum operations.

Data store 224 may be a repository for data to be analyzed using a quantum computing algorithm, as well as the results of such analysis. Data store 224 may be an implementation of storage 124 and/or remote database 130, described in more detail with reference to FIG. 1, configured to operate in a hybrid computing system 200.

The quantum system 230 can be any suitable set of components capable of performing quantum operations on a physical system. In the example embodiment depicted in FIG. 2, quantum system 230 includes a local classical controller 231, a classical-quantum interface 232, and quantum processor 233. In some embodiments, all or part of each of the local classical controller 231, a classical-quantum interface 232, and quantum processor 233 may be located in a cryogenic environment to aid in the performance of the quantum operations. In an embodiment, classical backend 220 and quantum system 230 may be co-located to reduce the communication latency between the devices.

Local classical controller 231 may be any combination of classical computing components capable of aiding a quantum computation, such as executing a one or more quantum operations to form a quantum circuit, by providing commands to a classical-quantum interface 232 as to the type and order of signals to provide to the quantum processor 233. Local classical controller 231 may additionally perform other low/no latency functions, such as error correction, to enable efficient quantum computations. Such digital computing devices may include processors and memory for storing and executing quantum commands using classical-quantum interface 232. Additionally, such digital computing devices may include devices having communication protocols for receiving such commands and sending results of the performed quantum computations to classical backend 220. Additionally, the digital computing devices may include communications interfaces with the classical-quantum interface 232. In an embodiment, local classical controller 231 may include all components of computer 101, or alternatively may be individual components configured for specific quantum computing functionality, such as processor set 110, communication fabric 111, volatile memory 112, persistent storage 113, and network module 115.

Classical-quantum interface 232 may be any combination of devices capable of receiving command signals from local classical controller 231 and converting those signals into a format for performing quantum operations on the quantum processor 233. Such signals may include electrical (e.g., RF, microwave, DC), optical signals, magnetic signals, or vibrational signals to perform one or more single qubit operations (e.g., Pauli gate, Hadamard gate, Phase gate, Identity gate), signals to preform multi-qubit operations (e.g., CNOT-gate, CZ-gate, SWAP gate, Toffoli gate), qubit state readout signals, and any other signals that might enable quantum calculations, quantum error correction, and initiate the readout of a state of a qubit. Additionally, classical-quantum interface 232 may be capable of converting signals received from the quantum processor 233 into digital signals capable of processing and transmitting by local classical controller 231 and classical backend 220. Such signals may include qubit state readouts. Devices included in classical-quantum interface 232 may include, but are not limited to, digital-to-analog converters, analog-to-digital converters, waveform generators, attenuators, amplifiers, filters, optical fibers, and lasers.

Quantum processor 233 may be any hardware capable of using quantum states to process information. Such hardware may include a collection of qubits, mechanisms to couple/entangle the qubits, and any required signal routings to communicate between qubits or with classical-quantum interface 232 in order to process information using the quantum states. Such qubits may include, but are not limited to, charge qubits, flux qubits, phase qubits, spin qubits, and trapped ion qubits, or any other suitable qubit structures. The architecture of quantum processor 233, such as the arrangement of data qubits, error correcting qubits, and the couplings amongst them, may be a consideration in performing a quantum circuit on quantum processor 233.

Referring now to FIG. 2B, a block diagram is depicted showing an example architecture, and data transmission, of hybrid computation system 250 employed using a cloud architecture for classical backend 220. Hybrid computation system 250 receives an algorithm containing a computation from a client application 211 of client device 210. Upon receipt of the algorithm and request from client application 211, hybrid computation system 250 instantiates a classical computing node 260 and a quantum computing node 270 to manage the parallel computations. The classical computing node 260 may include one or more classical computers capable of working in tandem. For example, classical computing node 260 may include an execution orchestration engine 261, one or more classical computation resources 223, and a result data store 224. The quantum computing node 270 may include a combination of classical and quantum computing components acting together to perform quantum calculations on quantum hardware including, for example, one or more quantum systems 230. The quantum computing node 270 may include a quantum runtime application 271 and one or more quantum systems 230.

The client application 211 may include programing instructions to perform quantum and classical calculations. In an embodiment, client application 211 may be in a general purpose computing language, such as an object oriented computing language (e.g., Python®), that may include classical and quantum functions and function calls. This may enable developers to operate in environments they are comfortable with, thereby enabling a lower barrier of adoption for quantum computation.

The execution orchestration engine 261, in using algorithm preparation 221, may parse the client application 211 into a quantum logic/operations portion for implementation on a quantum computing node 270, and a classical logic/operations portion for implementation on a classical node 260 using a classical computation resource 223. In an embodiment, parsing the client application 211 may include performing one or more data processing steps prior to operating the quantum logic using the processed data. In an embodiment, parsing the client application 211 may including segmenting a quantum circuit into portions that are capable of being processed by quantum computing node 270, in which the partial results of each of the segmented quantum circuits may be recombined as a result to the quantum circuit. Execution orchestration engine 261 may parse the hybrid algorithm such that a portion of the algorithm is performed using classical computation resources 223 and a session of quantum computing node 270 may open to perform a portion of the algorithm. Quantum runtime application 271 may communicate, directly or indirectly, with classical computation resources 223 by sending parameters/information between the session to perform parallel calculations and generate/update instructions of quantum assembly language to operate quantum system 230, and receiving parameters/information/results from the session on the quantum system 230. Following the parsing of the hybrid algorithm for calculation on quantum computing node 270 and classical computing node 260, the parallel nodes may iterate the session to convergence by passing the results of quantum circuits, or partial quantum circuits, performed on quantum system 230 to classical computing resource 223 for further calculations. Additionally, runtime application 271, using algorithm preparation 221, may re-parse aspects of the hybrid algorithm to improve convergence or accuracy of the result. Such operation results, and progress of convergence, may be sent back to client device 210 as the operations are being performed. By operating execution orchestration engine 261 in a cloud environment, the environment may scale (e.g., use additional computers to perform operations necessary) as required by the client application 211 without any input from the creators/implementors of client application 211. Additionally, execution orchestration engine 261, while parsing the client application 211 into classical and quantum operations, may generate parameters, function calls, or other mechanisms in which classical computation resource 223 and quantum computing node 270 may pass information (e.g., data, commands) between the components such that the performance of the computations enabled by client application 211 is efficient.

Classical computation resources 223 may perform classical computations (e.g., formal logical decisions, AI/ML algorithms, floating point operations, simulation of Quantum operations) that aid/enable/parallelize the computations instructed by client application 211. By utilizing classical computation resources 223 in an adaptively scalable environment, such as a cloud environment, the environment may scale (e.g., use additional computers to perform operations necessary including adding more classical computation resources 223, additional quantum systems 230, and/or additional resources of quantum systems 230 within a given quantum computing node 270) as required by the client application 211 without any input from the creators/implementors/developers of client application 211, and may appear seamless to any individual implementing client application 211 as there are no required programming instructions in client application 211 needed to adapt to the classical computation resources 223. Thus, for example, such scaling of quantum computing resources and classical computing resources may be provided as needed without user intervention. Scaling may reduce the idle time, and thus reduce capacity and management of computers in classical computing node 260.

Result data store 224 may store, and return to client device 210, states, configuration data, etc., as well as the results of the computations of the client application 211.

Implementation of the systems described herein may enable hybrid computing system 200, through the use of quantum system 230, to process information, or solve problems, in a manner not previously capable. The efficient parsing of the quantum or hybrid algorithm into classical and quantum segments for calculation may achieve efficient and accurate quantum calculations from the quantum system 230 for problems that are exponentially difficult to perform using classical backend 220. Additionally, the quantum assembly language created by classical backend 220 may enable quantum system 230 to use quantum states to perform calculations that are not classically efficient or accurate. Specifically, computational resources and processing time may be conserved through the identification of an optimal, or best-fit, circuit processing setup of quantum hardware available to a specific user. Such improvement may reduce the classical resources required to perform the calculation of the quantum or hybrid algorithm, by improving the capabilities of the quantum system 230.

Referring now to FIG. 3, a functional block diagram 300 of modules of a quantum setup selection program are depicted according to at least one embodiment. Quantum setup selection program 150 is depicted having multiple modules to aid in performing the method described in FIG. 4. The quantum setup selection program 150 may include selection module 302, scorer module 304, recommender engine 306, learner module 308, and ranker module 310.

Selection module 302 may be a program or subroutine the quantum setup selection program 150 utilizes to assess a user input circuit to determine whether execution of the circuit in the quantum system 230 should be performed with parallelization or without parallelization. Selection module 302 may assess whether parallelization is appropriate and, if so, which method of parallelization (i.e., inter-device or intra device) to use based on the quantum hardware devices available to the user for transpiling circuits. Selection module 302 may utilize the processing power of each available quantum hardware device, the current queuing delay for each available device, and the characteristics (e.g., size and resources required to transpile) of each circuit. Intra-device parallelization may relate to the accommodation of multiple circuits on a single hardware device due to the processing capabilities of the hardware device and the complexity of the circuits to be processed. Inter-device parallelization may relate to splitting a circuit into multiple subcircuits then processing each subcircuit on different hardware devices. Inter-device parallelization may accommodate larger circuits even if the user doesn't have access to large hardware devices. Additionally, inter-device parallelization may improve output quality. Once the subcircuits are processed through inter-device parallelization, the quantum setup selection program 150 may perform circuit knitting to aggregate the results of the processing.

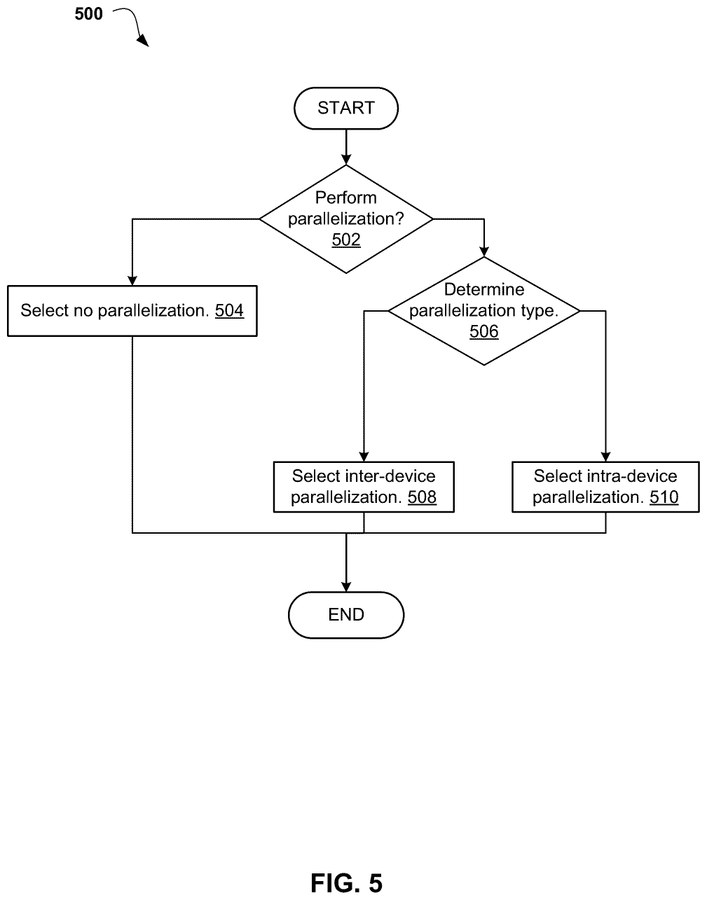

Referring now to FIG. 5, an operational flowchart for a selection module process 500 is depicted, according to at least one embodiment. At 502, the selection module 302 determines whether to perform parallelization. The selection module 302 may determine whether to perform parallelization when based on the available quantum hardware devices available to a user for transpiling, the number of qubits associated with the available quantum hardware devices either in total or individually, the current queuing delay for each available device, and the complexity of the circuit to be transpiled. If the selection module 302 determines no parallelization is necessary, the selection module process 500 may proceed to step 504 to selection no parallelization. If parallelization is determined to be necessary, the selection module process 500 may proceed to step 506 to determine which parallelization type (i.e., intra-device or inter-device) to perform. The selection module 302 may determine to perform intra-device parallelization when a circuit can be processed on a single quantum hardware unit should the circuit be separated so as to be transpilable on available hardware units. The selection module 302 may determine to perform inter-device parallelization when a circuit cannot be processed on a single quantum hardware unit but rather requires separation into smaller subcircuits to be processed on two or more available quantum hardware devices. If the selection module determines to perform inter-device parallelization, the selection module process 500 may proceed to step 508 to select inter-device parallelization. If the selection module determines to perform intra-device parallelization, the selection module process 500 may proceed to step 510 to select intra-device parallelization. Upon selecting no parallelization in step 504, inter-device parallelization in step 508, or intra-device parallelization in step 510, the selection module process 500 may end at which time the quantum setup selection program 150 may proceed to step 404 to generate a score.

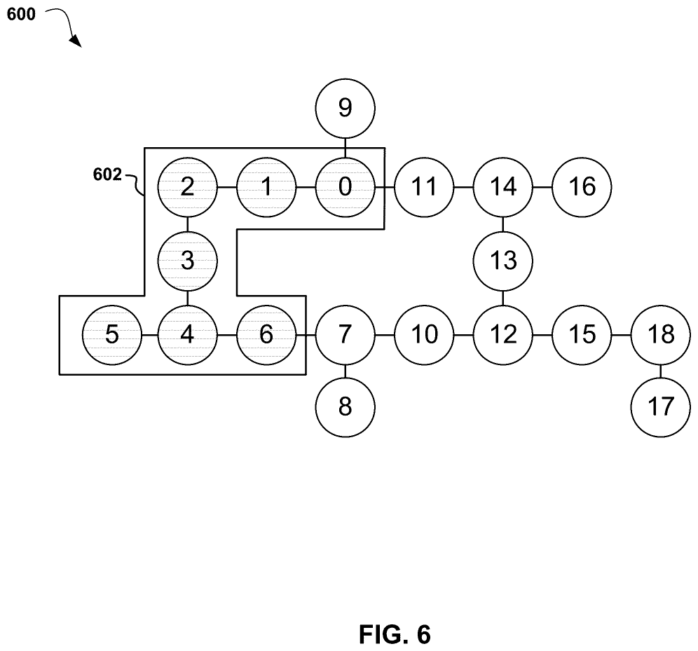

FIG. 6 illustrates a functional block diagram 600 of a quantum circuit executed without parallelization according to at least one embodiment. The quantum setup selection program 150 may determine no parallelization is necessary when the processing power of a quantum computer can transpile the circuit without separating the circuit into subcircuits for processing either by the same quantum device or multiple quantum devices depending on the current queuing delay for the device(s). For example, a quantum computer may be capable of processing a circuit 602 by itself without requiring the circuit 602 to be split into subcircuits and/or processed with the aid of another available quantum computer. In one or more embodiments, the quantum setup selection program 150 may also consider a queuing delay for the available quantum computing devices when determining whether parallelization is necessary. For example, if processing a circuit, such as circuit 602, on a quantum computing device with a high queueing delay would result in less efficient transpiling than if parallelization were performed, the quantum setup selection program 150 may determine to perform parallelization.

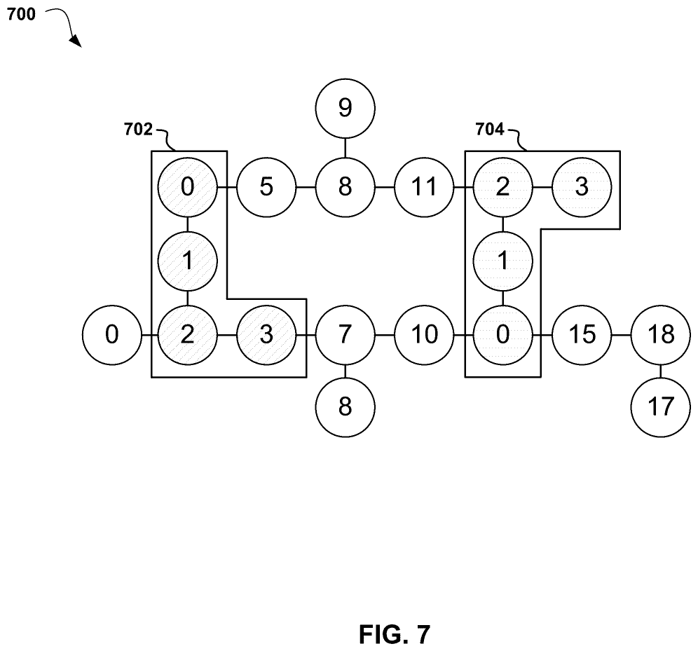

FIG. 7 illustrates a functional block diagram 700 of a quantum circuit executed with intra-device parallelization according to at least one embodiment. As previously described, if the quantum setup selection program 150 determines parallelization is needed due to an available quantum computing device being incapable of transpiling the circuit without splitting the circuit into subcircuits, the quantum setup selection program 150 may choose to perform intra-device parallelization. As previously described, intra-device parallelization may relate to the accommodation of multiple circuits on a single hardware device due to the processing capabilities of the hardware device and the complexity of the circuits to be processed. Intra-device parallelization may separate a circuit, such as circuit 602, into subcircuits, such as subcircuits 702 and 704, that can be transpiled on a single quantum computing device either concurrently or consecutively.

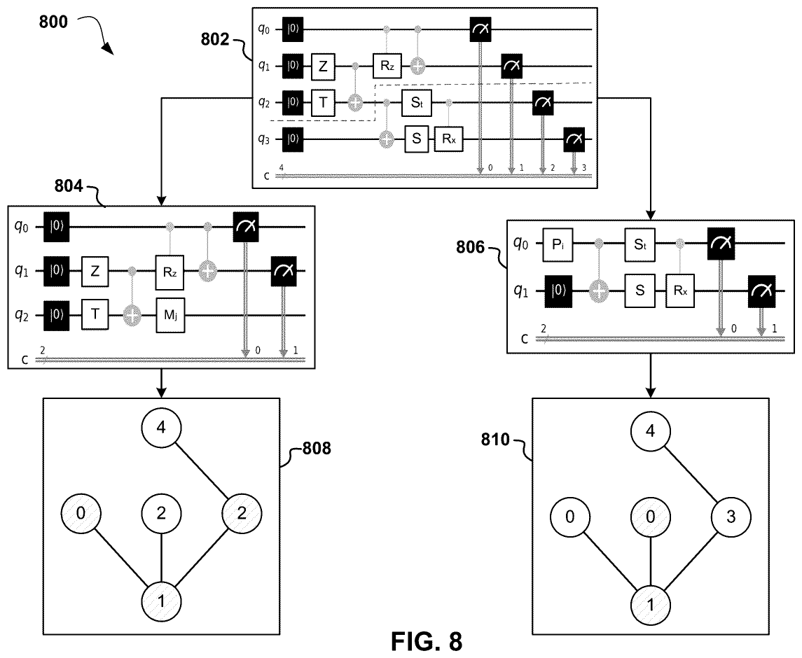

FIG. 8 illustrates a function block diagram 800 of a quantum circuit executed with inter-device parallelization according to at least one embodiment. As previously described, if the quantum setup selection program 150 determines parallelization is needed due to an available quantum computing device being incapable of transpiling the circuit without splitting the circuit into subcircuits, the quantum setup selection program 150 may choose to perform inter-device parallelization. Inter-device parallelization may relate to splitting a circuit into multiple subcircuits then processing each subcircuit on different hardware devices. Inter-parallelization may be appropriate with a single available quantum computing device is incapable of transpiling a circuit, such as circuit 802, so the circuit is separated into subcircuits, such as subcircuits 804 and 806, which are transpiled on separate quantum computers as transpiled circuits 808 and 810.

Referring back to FIG. 3, scorer module 304 may be a program that assigns a score to each circuit for each available hardware device in order to measure the resultant quality given the noise profile of each hardware device. The quantum setup selection program 150, through the scorer module 304, may generate a score for each hardware device that a subcircuit may be analyzed by since some subcircuits may receive less noise (e.g., degradation) with different hardware devices. For example, if an available quantum hardware unit has 127 qubits and a user-input circuit requires 10 qubits, the quantum setup selection program 150 may analyze the available qubits in the quantum hardware device to determine which qubit setup will return the least noise for the particular user-input circuit. As such, the quantum setup selection program 150 may calculate a score for each circuit setup in one or more available hardware units, rank the resulting scores based on the noise generated, and return the setups for each hardware setup with the lowest noise based on the score. Therefore, the quantum setup selection program 150 may be able to determine an optimal processing setup of multiple hardware devices on which to perform inter-device parallelization. The scorer module 304 may also consider a queuing delay for each available hardware device given the current demand on each device. Table 1, depicted below, provides an exemplary scenario as to resultant scores calculated for various locational layouts for quantum processing.

TABLE 1

| Hardware Layout | Location | Score |
|---|---|---|
| [5, 3, 2, 1, 0, 4] | IBM Hanoi | 0.086038792 |
| [36, 51, 50, 49, 48, 55] | IBM | 0.091501022 |
| | Washington | |
| [21, 23, 24, 25, 22, 26] | IBM Auckland | 0.966675096 |
| [5, 8, 11, 14, 16, 13] | IBM Montreal | 0.101019181 |
| [21, 23, 24, 25, 22, 26] | IBM Cairo | 0.103105089 |
| [6, 5, 3, 1, 0, 2] | IBM Lagos | 0.108066914 |
| [16, 19, 22, 25, 24, 26] | IBM Mumbai | 0.119277195 |
| [24, 25, 22, 19, 20, 16] | IBM Toronto | 0.137249351 |
| [24, 29, 30, 31, 32, 39] | IBM Brooklyn | 0.153791579 |
| [13, 14, 11, 8, 5, 9] | IBM Guadalupe | 0.157547634 |
| [4, 5, 3, 1, 0, 2] | IBM Casablanca | 0.179016284 |
| [6, 5, 3, 1, 0, 2] | IBM Perth | 0.180246033 |
| [4, 5, 3, 1, 2, 0] | IBM Jakarta | 0.187441205 |

Recommender engine 306 may be a machine learning model that considers the previous execution history for similar circuits and suggests a set of hardware deemed suitable to process the circuit. Recommender engine 306 is discussed in further detail with respect to step 406 below.

Learner module 308 may be a program that captures the score for each hardware and predicts an expected quality degradation, queuing delay, running time, and classical overhead (for circuit-knitting) for each hardware and for each error mitigation technique, when applicable. Learner module 308 is described in further detail with respect to step 406 below.

Ranker module 310 may be a program that provides a table to the user which illustrates the queuing delay, estimated runtime, estimated quality degradation and estimated classical overhead for each hardware that can be sorted according to time/quality or any other preconfigured metric designated by the user.

Once the user identifies and selects a layout as displayed by the ranker module 310, the quantum setup selection program 150 may enable execution of the circuit according to the desired hardware setup on execution orchestration engine 261. In one or more embodiments, the quantum setup selection program 150 may execute the circuit receiving the most desirable score through execution orchestration engine 261 automatically without requiring user selection based on user preconfigurations.

Referring now to FIG. 4, an operational flowchart for a quantum setup selection process 400 is depicted according to at least one embodiment. At 402, the quantum setup selection program 150 receives user inputs. The user inputs may include the circuits that the user wishes to be processed by the quantum system 230 and the access credentials, or access privileges, to specific quantum hardware units associated with a user. Based on the user credentials, the quantum setup selection program 150 may identify each quantum hardware device available to the user for processing calculations appropriate for the input circuit.

Then, at 404, the quantum setup selection program 150 identifies a parallelization type based on the user inputs and one or more available hardware. As previously described, the quantum setup selection program 150 may determine whether to execute the circuits received from the user through parallelization. The quantum setup selection program 150 may determine whether to proceed with parallelization based on whether the available hardware is adequate enough to process the circuit without separating the circuit into subcircuits and based on a current queuing delay for each available hardware unit. For example, if there is little queuing delay for a device capable of processing the circuit without the use of other hardware devices, the quantum setup selection program 150 may determine that no parallelization is necessary. However, if a queuing delay is present and/or hardware devices are not capable of processing the circuit without separating the circuit into more manageable subcircuits, the quantum setup selection program 150 may determine parallelization is proper. If parallelization is determined to be appropriate, the quantum setup selection program 150 may proceed with determining whether to proceed with intra-device parallelization or inter-device parallelization. As previously described, intra-device parallelization may relate to the accommodation of multiple circuits on a single hardware device due to the processing capabilities of the hardware device and the complexity of the circuits to be processed and inter-device parallelization may relate to splitting a circuit into multiple subcircuits then processing each subcircuit on different hardware devices.

Next, at 406, the quantum setup selection program 150 generates a score for the one or more hardware units associated with the parallelization type using noise information and a pretrained machine learning model. For each hardware device, the quantum setup selection program 150 generates a score that considers the noise information for each hardware device. The scoring method, utilized by scorer module 304, makes use of the calibration data for each hardware device and learns the noise generated by the device in real time in order to generate the score.

In one or more embodiments, the quantum setup selection program 150 may also utilize a recommender engine 306. As previously described, the recommender engine 306 may be a machine learning model that considers the previous execution history for similar circuits and suggests a set of hardware deemed suitable to process the circuit above threshold efficiency value (e.g., time-related or degradation-related). In an embodiment, the recommender engine 306 may determine a previously executed circuit to be similar to the instant, user-submitted circuit if both circuits originate from the same family of algorithms (e.g., variational quantum eigensolver (VQE) or quantum-enhanced support vector machine (QSVM)). In another embodiment, the recommender engine 306 may analyze the gate structure of the instant circuit and a previously-executed circuit to exactness or similarities (e.g., 2-qubit gate structure). In yet another embodiment, the recommender engine 306 may determine whether the instant circuit and a previous circuit result in the same, or similar within a threshold value, statevectors. In a further embodiment, the recommender engine 306 may determine the instant circuit and the previously executed circuit are similar when a preconfigured number of characteristics match between the two circuits, such as number of qubits, number of quantum gates, family of originating algorithms, etc. For a specific circuit, the recommender engine 306 may identify a preconfigured number of hardware setups, or orientations, that users selected in similar circuits. The hardware setups may include, but are not limited to, the hardware utilized and a type of error mitigation to be used (e.g., Memory Exploit Mitigation (MEM), Zero-Noise Extrapolation (ZNE), and Probabilistic Error Cancellation (PEC)). In one or more embodiments, the recommender engine 306 may act as a filtering mechanism for learner module 308. If no recommendation is available for a specific circuit, such as a circuit being the first of its type received by the quantum setup selection program 150, then the whole input is passed to the learner module without a recommendation being made. The quantum setup selection program 150 may receive the user's selection of the preconfigured number of hardware setups recommended by the recommender engine 306 and transmit that selection to the learner module 308.

In one or more further embodiments, the quantum setup selection program 150 may utilize the learner module 308. As previously described, the learner module 308 may be a program that captures the score for each hardware and predicts an expected quality degradation, queuing delay, running time, and classical overhead (for circuit-knitting) for each hardware and for each error mitigation technique, when applicable. The learner module 308 may be pretrained on multiple families of circuits (e.g., variational quantum eigensolver (VGE), quantum machine learning (QML), and randomized benchmarking (RB)) for different mitigations. The learner module 308 may store scores (e.g., a fidelity value with ideal simulation and an expectation value) calculated by scorer module 302 corresponding to each circuit and hardware device then when circuits are executed on the corresponding hardware devices. The learner module 308 may utilize the stored scores as a training set for a regression model that itself may be stored in a repository, such as storage 124.

Additionally, the learner module 308 may learn both quantum and classical overheads for different parallelization techniques (e.g., intra-device parallelization and inter-device parallelization) and different error mitigation methods. Using the pretrained model for a new circuit may predict scores for each hardware available to a user and error mitigation techniques provided by the recommendation engine 306 as well as predict the quantum and classical overhead for specific setups.

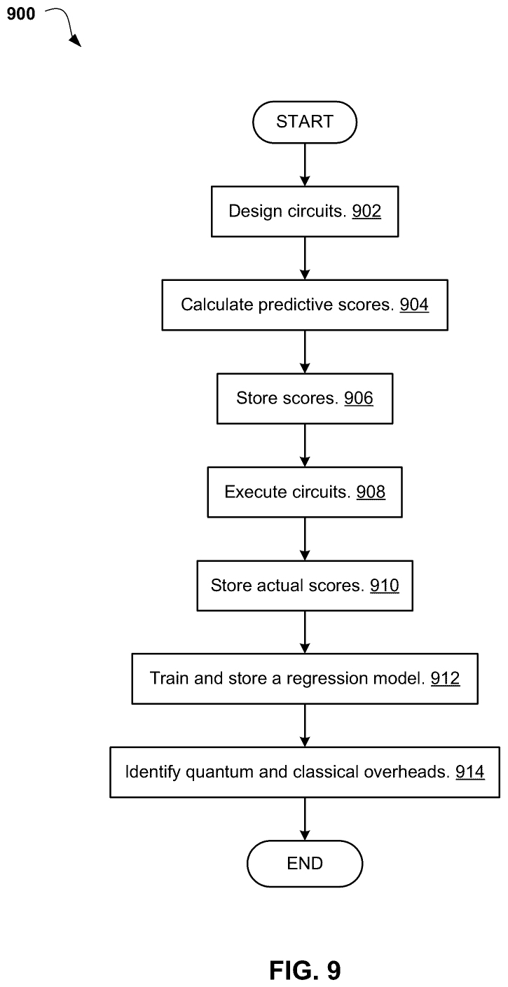

Referring now to FIG. 9, an operational flowchart of a learner module pretraining process 900 of a machine learning model on multiple families of circuits according to at least one embodiment. Learner module 308 may pretrain a machine learning model on multiple families of circuits (e.g., variational quantum eigensolver (VQE), quantum machine learning (QML), and randomized benchmarking (RB)) for different mitigation techniques. At 902, the learner module 308 may design circuits with the number of qubits n_{qubit}∈{1,n} at a gap of Δn and depth d∈{1,d} at a gap of Δd. Then, at 904, the learner module 308 may calculate predictive scores of each circuit c for a set of hardware Hₜᵣₐᵢₙ∈Hₐₗₗ where Hₐₗₗ is the set of all hardware. Next, at 906, the learner module 308 may store the score S_{ch} corresponding to each circuit c and each hardware h∈Hₜᵣₐᵢₙ. Then, at 908, the learner module 308 may execute each circuit c on each hardware h∈Hₜᵣₐᵢₙ to output a value V_{chm} for a corresponding mitigation technique m∈M. Next, at 910, the learner module 308 may store the value V_{chm} for the corresponding mitigation technique m∈M. Then, at 912, the learner module 308 may train and store a regression model using the training set {S_{ch}, V_{chm}}. Next, at 914, the learner module 310 identifies quantum and classical overheads for different parallelization techniques and different error mitigation techniques m∈M using the regrestion model. Additionally, using the pretrained model, the learner module 308 may predict the value V for each hardware hᵣₑ and error mitigation technique mᵣₑ provided by the recommender engine 306 as well as predict the quantum and classical overhead for a new circuit.

Referring back to FIG. 4, at 408, the quantum setup selection program 150 generates outputs for the one or more hardware units based on the score. The quantum setup selection program 150 may output a table predicting the setups, or orientations of hardware units, which are expected to provide the best outcomes in terms of performance, queuing delay, or any other desired and/or preconfigured metric. The quantum setup selection program 150 may sort the table according to user specified criteria. For example, the quantum setup selection program 150 may generate an output table to include headings for hardware name (HW), queue time, quality degradation as a percentage, mitigation method, run time, and classical computing overhead as depicted in Table 1.

| | | Quality | | | |
|---|---|---|---|---|---|
| | Queue | Degradation | | | Classical |
| HW | Time | (%) | Mitigation | Run Time | Overhead |
| H₁ | d₁ | x₁m₁ | m₁ | t₁m₁ | c₁ |
| H₁ | d₁ | x₁m₂ | m₂ | t₁m₂ | c₁ |
| H₂ | d₂ | x₂m₁ | m₁ | t₂m₁ | c₂ |
| . . . | | | | | |
| Hₖ | dₖ | xₖm₂ | m₂ | tₖmₖ | cₖ |

Additionally, the user may select the most desirable setup (e.g., hardware to use, mitigation technique to use, whether to use parallelization and, if so, parallelization type, etc.) from the generated table. The selected setup may be passed to the learner module 308 to train the model for future setups and iterations similar to the instant circuit. The expectation value observed in the chosen setup may also be used as feedback to train the machine learning model utilized by the learner module 308 in an online-learning framework to predict the actual expectation values for all hardware devices.

In one or more embodiments, the quantum setup selection program 150 may predict expectation values for other hardware devices based on the machine learning model utilized by the learner module 308. The quantum setup selection program 150 may learn the ideal expectation curve using machine learning for a given family of circuits using different setups. For example, if a user selects a recommended setup for a circuit, the quantum setup selection program 150 may predict the expected value of the circuit under ideal circumstances based on historical data. Therefore, if the user executes a different circuit from the same family, which may include different depth and/or different parameters, a different range of expectation values may be plotted against the ideal curve of expectation values. Since a new circuit plotted against the ideal curve should be from the same circuit family, the quantum setup selection program 150 may assume the nature of the curve remains the same even if the actual range does not remain the same. Since the ideal expectation value curve relates to other expectation values in the same family, an expectation value for a specific hardware device may allow the quantum setup selection program 150 to estimate the score for other available hardware devices since the other scores should relate to the score of the hardware device proportionally according to the ideal expectation value curve.

It may be appreciated that FIGS. 3 and 4 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
receiving a quantum circuit and one or more user credentials;
identifying one or more quantum hardware units available to a user based on the user credentials and the quantum circuit;
generating a score for an orientation of the one or more quantum hardware units and the quantum circuit using noise information and a queuing delay for the one or more quantum hardware units and a pretrained machine learning model; and
generating outputs for the orientation based on the generated scores.

2. The method of claim 1, further comprising:
determining whether to utilize parallelization based on the quantum circuit and the one or more quantum hardware units; and
in response to determining to utilize parallelization, identifying a parallelization type based on the quantum circuit and the one or more quantum hardware units.

3. The method of claim 1, wherein the pretrained machine learning model is trained from a previous execution history for circuits with a preconfigured number of similarities as a quantum circuit and suggests a set of quantum hardware suitable to process the quantum circuit to satisfy a threshold.

4. The method of claim 3, wherein the pretrained machine learning model utilizes a training module to predict a quality degradation, queueing delay, running time, and classical computing overhead for each quantum hardware unit and an error mitigation technique for a particular orientation of the one or more quantum hardware units.

5. The method of claim 1, wherein the one or more outputs are selected from a group consisting of a queue time for a quantum hardware unit, a quality degradation for the quantum hardware unit, a mitigation method utilized, a run time, and classical computer overhead.

6. The method of claim 2, wherein the parallelization type comprises intra-device parallelization and inter-device parallelization.

7. The method of claim 1, further comprising:
executing the circuit on the orientation with the score satisfying a preconfigured threshold.

8. A computer system, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
receiving a quantum circuit and one or more user credentials;
identifying one or more quantum hardware units available to a user based on the user credentials and the quantum circuit;
generating a score for an orientation of the one or more quantum hardware units and the quantum circuit using noise information and a queuing delay for the one or more quantum hardware units and a pretrained machine learning model; and
generating outputs for the orientation based on the generated scores.

9. The computer system of claim 8, wherein the method further comprises:
determining whether to utilize parallelization based on the quantum circuit and the one or more quantum hardware units; and
in response to determining to utilize parallelization, identifying a parallelization type based on the quantum circuit and the one or more quantum hardware units.

10. The computer system of claim 8, wherein the pretrained machine learning model is trained from a previous execution history for circuits with a preconfigured number of similarities as a quantum circuit and suggests a set of quantum hardware suitable to process the quantum circuit to satisfy a threshold.

11. The computer system of claim 10, wherein the pretrained machine learning model utilizes a training module to predict a quality degradation, queueing delay, running time, and classical computing overhead for each quantum hardware unit and an error mitigation technique for a particular orientation of the one or more quantum hardware units.

12. The computer system of claim 8, wherein the one or more outputs are selected from a group consisting of a queue time for a quantum hardware unit, a quality degradation for the quantum hardware unit, a mitigation method utilized, a run time, and classical computer overhead.

13. The computer system of claim 9, wherein the parallelization type comprises intra-device parallelization and inter-device parallelization.

14. The computer system of claim 8, further comprising:
executing the circuit on the orientation with the score satisfying a preconfigured threshold.

15. A computer program product, the computer program product comprising:
one or more computer-readable tangible storage media and program instructions stored on at least one of the one or more tangible storage media, the program instructions executable by a processor capable of performing a method, the method comprising:
receiving a quantum circuit and one or more user credentials;
identifying one or more quantum hardware units available to a user based on the user credentials and the quantum circuit;
generating a score for an orientation of the one or more quantum hardware units and the quantum circuit using noise information and a queuing delay for the one or more quantum hardware units and a pretrained machine learning model; and
generating outputs for the orientation based on the generated scores.

16. The computer program product of claim 15, wherein the method further comprises:
determining whether to utilize parallelization based on the quantum circuit and the one or more quantum hardware units; and
in response to determining to utilize parallelization, identifying a parallelization type based on the quantum circuit and the one or more quantum hardware units.

17. The computer program product of claim 15, wherein the pretrained machine learning model is trained from a previous execution history for circuits with a preconfigured number of similarities as a quantum circuit and suggests a set of quantum hardware suitable to process the quantum circuit to satisfy a threshold.

18. The computer program product of claim 17, wherein the pretrained machine learning model utilizes a training module to predict a quality degradation, queueing delay, running time, and classical computing overhead for each quantum hardware unit and an error mitigation technique for a particular orientation of the one or more quantum hardware units.

19. The computer program product of claim 15, wherein the one or more outputs are selected from a group consisting of a queue time for a quantum hardware unit, a quality degradation for the quantum hardware unit, a mitigation method utilized, a run time, and classical computer overhead.

20. The computer program product of claim 16, wherein the parallelization type comprises intra-device parallelization and inter-device parallelization.
